(19) United States
(12) Patent Application Publication
(10) Pub. No.: US 2025/0076020 A1
(43) Pub. Date: Mar. 6, 2025

(54) GUIDE FOR ALIGNING ELECTRICAL SWITCHES AND OUTLETS IN A MULTIPLE GANG ELECTRICAL BOX

(71) Applicant: Bradley J. Ebner, Winnipeg (CA)

(72) Inventor: Bradley J. Ebner, Winnipeg (CA)

(21) Appl. No.: 18/820,938

(22) Filed: Aug. 30, 2024

Related U.S. Application Data
(60) Provisional application No. 63/580,131, filed on Sep. 1, 2023.

(51) Int. Cl. G01B 5/16

(52) U.S. Cl. CPC G01B 5/16

(57) ABSTRACT

A guide aligns electrical devices such as switches and outlets that are mounted in a longitudinal row within a multiple gang electrical box prior to mounting a faceplate on the electrical box in which the faceplate includes a row of apertures receiving face portions of the electrical devices respectively therein. The guide has a main body and at least one guide finger protruding from the main body transversely to a longitudinal direction of the main body towards a free distal end of the guide finger. The guide finger(s) have guide surfaces extending parallel to one another at opposing sides of the guide finger, spaced at a prescribed distance equal to an aperture distance between the apertures in the faceplate. The fingers can be inserted between electrical devices to align the devices relative to the box before mounting the faceplate.

This application claims the benefit under 35 U.S.C. 119(e) of U.S. provisional application Ser. No. 63/580,131, filed Sep. 1, 2024.

### FIELD OF THE INVENTION

The present invention relates to a guide for aligning electrical switches and outlets with one another when mounting onto a multiple gang electrical box, prior to mounting of a faceplate onto the box.

### BACKGROUND

Electrical devices such as switches and outlets are commonly mounted in a row by mounting the electrical devices in a multiple gang electrical box. A faceplate is then mounted over the electrical box in which the faceplate has a row of apertures receiving a face portion of each electrical device protruding therethrough for access by a user. The electrical devices are adjustably mounted onto the electrical box, but it can be a time-consuming task to mount the electrical devices in proper alignment with one another at a proper spacing so that the face portions of the electrical devices are properly aligned with the apertures in the faceplate to be subsequently mounted on the electrical box.

### SUMMARY OF THE INVENTION

According to one aspect of the invention there is provided an alignment guide for aligning electrical devices mounted in a longitudinal row within a multiple gang electrical box prior to mounting a faceplate on the electrical box in which the faceplate includes a row of apertures receiving face portions of the electrical devices respectively therein, the alignment guide comprising:
a main body arranged to extend in a longitudinal direction along the longitudinal row of electrical devices; and
at least one guide finger protruding from the main body transversely to the longitudinal direction towards a free distal end of the guide finger, said at least one guide finger having a pair of finger guide surfaces extending parallel to one another at opposing sides of the guide finger in which the finger guide surfaces are spaced apart from one another at a prescribed distance, said prescribed distance being equal to an aperture distance between the apertures in the faceplate in a direction of the longitudinal row.

Preferably said at least one guide finger comprises a plurality of guide fingers spaced apart from one another in the longitudinal direction of the main body, each adjacent pair of the guide fingers being spaced apart from another by a prescribed spacing which is equal to a width of the apertures in the face plate in a direction of the row of apertures.

More particularly, said at least one guide finger may comprise three guide fingers defining two of said prescribed spacings between respective adjacent pairs of the guide fingers.

Preferably a fastener aperture is formed in the main body at a longitudinally centered location between each adjacent pair of the guide fingers.

The alignment guide preferably further comprises an end guide surface on the main body on opposing sides of said at least one guide finger, in which the end guide surfaces are co-linear with one another and in which the end guide surfaces are perpendicular to the finger guide surfaces.

The opposing sides of said at least one finger may be tapered towards one another adjacent the free distal end.

The guide may further include a level bubble supported on the guide to extend in the longitudinal direction of the main body so as to indicate angular deflection of the longitudinal direction from a horizontal plane.

According to a second aspect of the present invention there is provided a method of using the alignment guide comprising the steps of:
(i) mounting each electrical device in the multiple gang electrical box in said longitudinal row using a partially fastened first screw at a first end of each electrical device and a partially fastened second screw at a second end of each electrical device;
(ii) inserting a first guide finger among the at least one guide fingers of the alignment guide between a first electrical device and a second electrical device among the electrical devices mounted on the multiple gang electrical box such that the face portion of the first electrical device is abutted with one of the finger guide surfaces and the face portion of the second electrical device is abutted with another one of the finger guide surfaces; and
(iii) tightening the first screws of the first electrical device and the second electrical device while the face portions remain abutted with the finger guide surfaces of the first guide finger respectively.

The method may further include sliding the alignment guide into and out of engagement with the electrical devices along an axis parallel to the finger guide surfaces.

The method may further include: (i) abutting the main body against the face portion of the electrical devices at the first end of the electrical devices when tightening the first screws; (ii) subsequently inserting the first guide finger between the first and second electrical devices until the main body is abutted against the face portion of the electrical device at the second end of the electrical devices; and (iii) tightening the second screws of the first electrical device and the second electrical device while the face portions remain abutted with the finger guide surfaces of the first guide finger respectively.

The method may further include: (i) inserting the first guide finger between the second electrical device and a third electrical device among the electrical devices mounted on the multiple gang electrical box such that the face portion of the second electrical device is abutted with one of the finger guide surfaces and the face portion of the third electrical device is abutted with another one of the finger guide surfaces; and (ii) tightening the first screw of the third electrical device while the face portions of the second and third electrical devices remain abutted with the finger guide surfaces of the first guide finger respectively.

### BRIEF DESCRIPTION OF THE DRAWINGS

One embodiment of the invention will now be described in conjunction with the accompanying drawings in which:

FIG. 1 is a perspective view of a first embodiment of the alignment guide;

FIG. 2 is a front elevational view of the alignment guide according to the first embodiment of FIG. 1;

FIG. 3 is a perspective view of the alignment guide according to the first embodiment of FIG. 1 shown in use relative to a pair of electrical devices to be mounted in an electrical box;

FIG. 4 is a front elevational view of the alignment guide according to FIG. 3;

FIG. 5 is a perspective view of the alignment guide according to the first embodiment of FIG. 1 shown inserted between first and second electrical devices of a row of electrical devices;

FIG. 6 is a perspective view of the alignment guide being inserted between second and third electrical devices of the row of electrical devices;

FIG. 7 is a perspective view of the alignment guide fully inserted between the second and third electrical devices of the row of electrical devices;

FIG. 8 is a perspective view of the alignment guide being inserted between third and fourth electrical devices of the row of electrical devices; and

FIG. 9 is a schematic representation of a row of electrical devices to be mounted in a multiple gang electrical box prior to mounting of a faceplate with which the alignment guide according to the present invention is used.

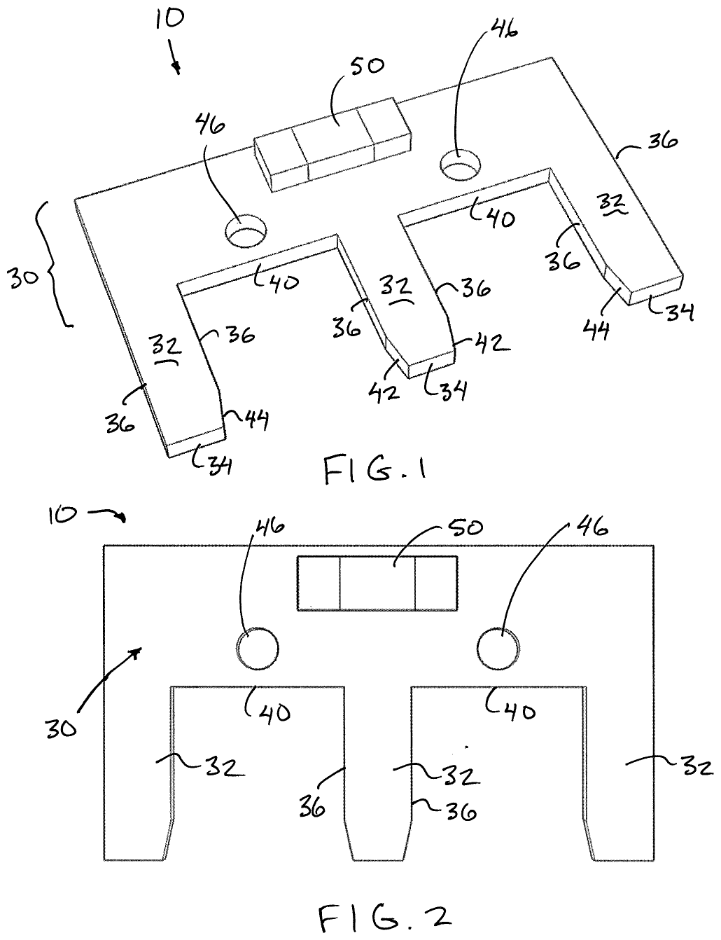

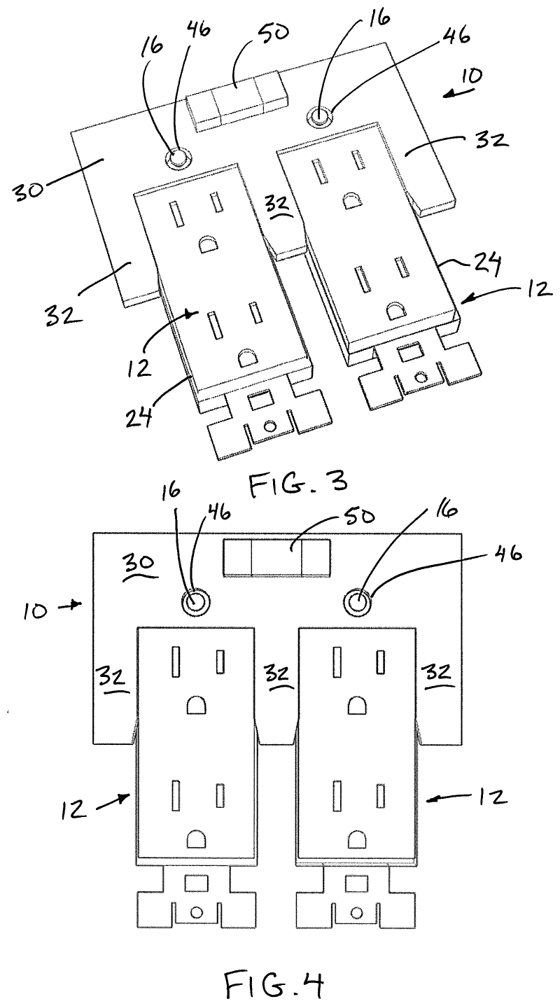

In the drawings like characters of reference indicate corresponding parts in the different figures.

### DETAILED DESCRIPTION

Referring to the accompanying figures there is illustrated an alignment guide generally indicated by reference numeral 10. The alignment guide is particularly suited for aligning electrical devices 12 (for example electrical switches and electrical outlets) relative to a multiple gang electrical box 14 (for example a 2 gang, 3 gang, 4 gang, etc.) such that the electrical devices are aligned in a longitudinal row. Each electrical device 12 is typically mounted onto the electrical box 14 using a first screw 16 fastened at a first end of the electrical device and a second screw 18 fastened at a second end of the electrical device. A faceplate 20 is typically mounted overtop of the electrical box 14 subsequent to mounting of the electrical devices 12 therein. The faceplate includes a row of apertures 22 formed therein at a prescribed spacing between each pair of apertures in the row such that the apertures are arranged for alignment with face portions 24 of the respective electrical devices. Each aperture 22 is closely sized to the dimensions of the face portion 24 of the corresponding electrical device such that the face portion is received within the aperture to be visible and accessible to a user.

The alignment guide 10 generally includes a main body 30 extending in a longitudinal direction for alignment with the longitudinal row of electrical devices in use, and a plurality of guide fingers 32 which protrude from one side of the main body in a direction perpendicular to the longitudinal direction of the main body. Each guide finger 32 protrudes from the main body towards a respective free distal end 34 of the finger. Each guide finger includes a pair of parallel guide surfaces 36 formed thereon at longitudinally opposed sides of the guide finger in which the guide surfaces 36 are spaced apart from one another at a prescribed distance which is equal to the prescribed space between apertures 22 in the row of apertures of the faceplate 20.

The entirety of the alignment guide 10 may be cut from a single flat plate or sheet of rigid plastic material or other suitably rigid materials. Alternatively, the alignment guide 10 may be manufactured as a single unitary body of material which is continuous throughout by injection moulding or three-dimensional printing techniques.

In the illustrated embodiment, the guide 10 includes a set of three fingers 32 protruding from the main body 30 so as to define a pair of outer fingers at opposing ends of the main body and an intermediate finger at a longitudinally centred location between the outer fingers. Each adjacent pair of the fingers defines a respective open space 38 therebetween which is unbounded and open at one end between the free distal ends 34 of the fingers opposite to the main body 30. The fingers remain free and unsupported at the distal ends 34 thereof.

The inner side of the main body 30 from which the fingers protrude defines a pair of end guide surfaces 40 at opposing sides of the intermediate finger in the longitudinal direction of the main body. The end guide surfaces 40 are perpendicular to the finger guide surfaces 36 and are co-linear with one another so as to be suitable for abutting one end of the face portions 24 of the electrical devices when the intermediate finger among the guide fingers 32 is inserted between a pair of electrical devices to be aligned.

The intermediate finger among the guide fingers 32 includes an end portion adjacent to the distal end in which the opposing sides of the finger includes tapered edges 42 which are tapered inwardly towards one another as they extend away from the guide surfaces 36 towards the distal end of the finger. The outer fingers among the guide fingers 32 similarly include a tapered edge 44 along a respective end portion of the finger in which the tapered edge 44 is provided along the innermost side of the finger closest to the intermediate finger. The opposing side of the finger corresponding to the outermost side of the finger farthest from the intermediate finger may or may not include a similar tapered edge 44.

The main body 30 further includes a fastener aperture 46 formed therein at a location which is longitudinally centred relative to a respective one of the spaces 38 between an adjacent pair of fingers so as to be longitudinally centred relative to the fingers of the adjacent pair. Furthermore, the fastener aperture 46 is situated relative to the end guide surface 40 such that when the end guide surface is abutted with an end of the face portion 24 of one of the electrical devices, the fastener aperture 46 is aligned with a mounting location of the corresponding first or second screw 16 or 18. The fastener aperture 46 is suitably sized to receive the entirety of the first or second screw 16 or 18 therethrough including the head of the screw to provide accessibility for mounting and tightening the screws while the alignment guide remains abutted with the electrical devices to maintain their respective alignment with one another while tightening the screws.

The guide further includes a level bubble 50 supported on the guide to extend in the longitudinal direction of the main body so as to indicate angular deflection of the longitudinal direction from a horizontal plane.

In use, an operator initially mounts a row of electrical devices 12 within the electrical box 14 using the screws 16 and 18 in which the screws are initially only partially fastened so that the electrical devices 12 remain adjustable relative to one another and relative to the electrical box. Before mounting of the faceplate 20, the alignment guide 10 is used to align the electrical devices relative to one another.

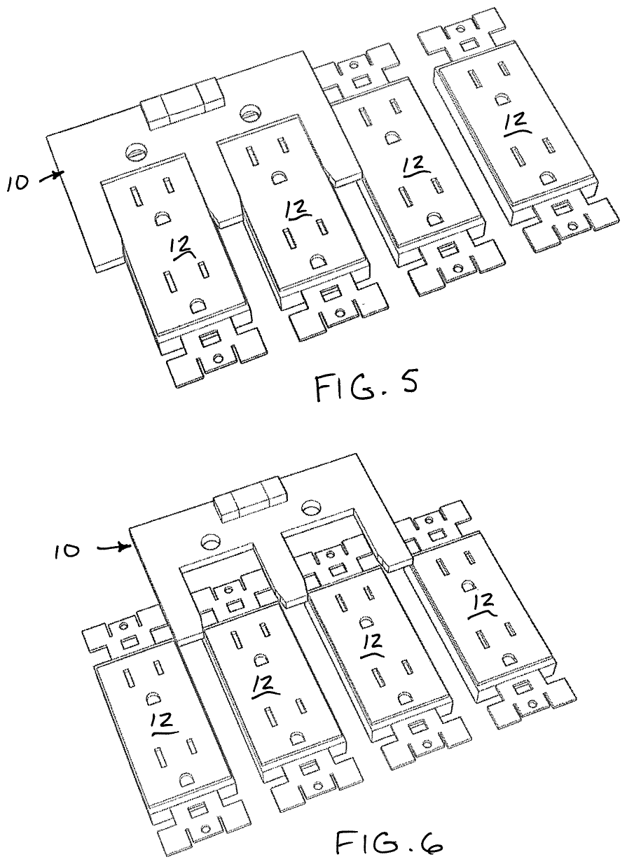

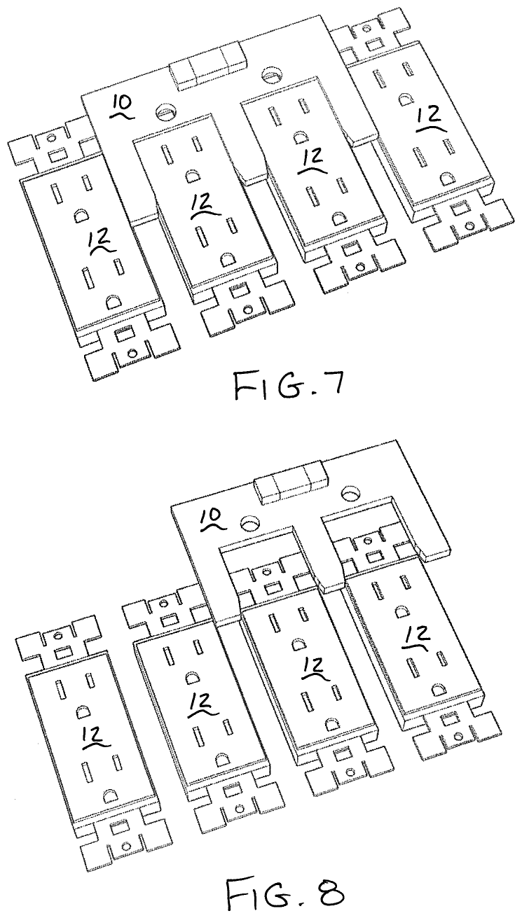

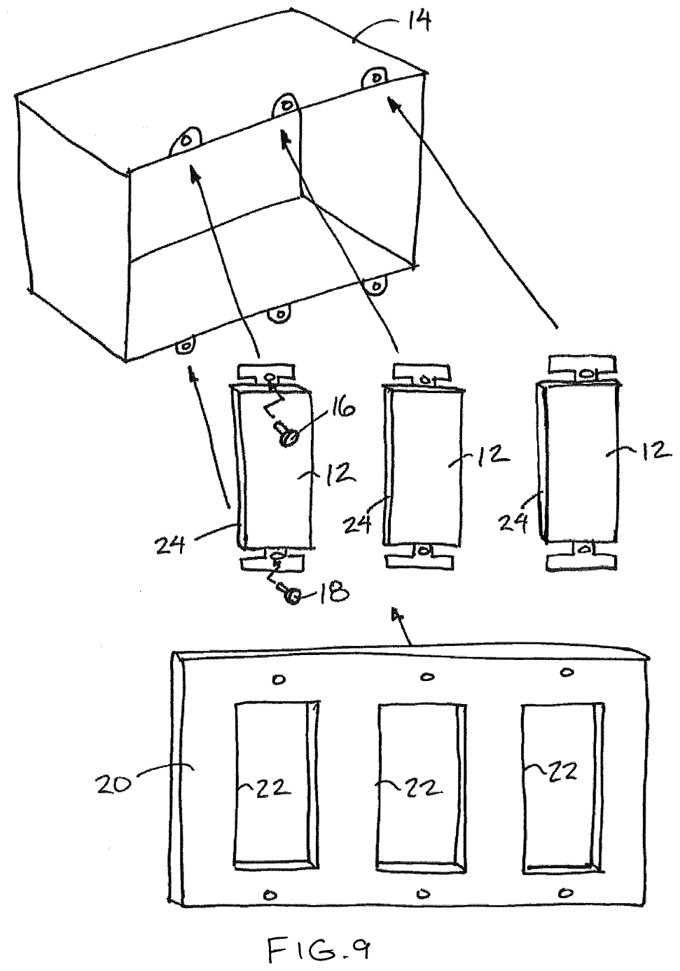

In a first step, the intermediate finger is inserted between first and second electrical devices within a row of electrical devices as shown in FIG. 5 with the end guide surfaces 40 being abutted with the ends of the face portions 24 of the electrical devices at the first ends of the devices. The outer fingers serve to hold the face portions of the first and second electrical devices snugly against the guide surfaces 36 at opposing sides of the intermediate finger among the guide fingers 32. The user also ensures that the level bubble 50 indicates that the longitudinal direction of the main body is horizontal. While the guide surfaces remain firmly held against the corresponding surfaces of the first and second electrical devices, and the longitudinal direction of the main body remains horizontal, the first screws 16 of the first and second electrical devices are tightened.

The user then repeats the above steps by inserting the intermediate finger between second and third devices 12 within the row of devices so that the first screw of the third device can be tightened. This process is repeated until all first screws 16 of the electrical devices 12 are tightened.

The user then inserts the intermediate finger between the first and second electrical devices such that the end guide surfaces 40 are abutted with the face portions 24 of the electrical devices at the second ends thereof so that the second screws 18 of the first and second electrical devices can be tightened. This process is then again repeated along the row of electrical devices 12 until all second screws 18 are tightened.

In each instance, the alignment guide 10 is engaged with and removed from the electrical devices by vertical sliding of the alignment guide relative to the electrical devices along a sliding axis oriented parallel to the finger guide surfaces 36 of the fingers.

Tightening of all of the first and second screws is accomplished by inserting a suitable screwdriver tool through the respective fastener apertures 46 in the guide 10 to access the screws. After removal of the alignment guide 10, the faceplate 20 can be mounted onto the electrical box 14 with the face portions 24 of the electrical devices 12 all being suitably aligned with corresponding apertures 22 in the faceplate 20.

Since various modifications can be made in the invention as herein above described, and many apparently widely different embodiments of same made, it is intended that all matter contained in the accompanying specification shall be interpreted as illustrative only and not in a limiting sense.

1. An alignment guide for aligning electrical devices mounted in a longitudinal row within a multiple gang electrical box prior to mounting a faceplate on the electrical box in which the faceplate includes a row of apertures receiving face portions of the electrical devices respectively therein, the alignment guide comprising:
a main body arranged to extend in a longitudinal direction along the longitudinal row of electrical devices; and
at least one guide finger protruding from the main body transversely to the longitudinal direction towards a free distal end of the guide finger, said at least one guide finger having a pair of finger guide surfaces extending parallel to one another at opposing sides of the guide finger in which the finger guide surfaces are spaced apart from one another at a prescribed distance, said prescribed distance being equal to an aperture distance between the apertures in the faceplate in a direction of the longitudinal row.

2. The alignment guide according to claim 1 wherein said at least one guide finger comprises a plurality of guide fingers spaced apart from one another in the longitudinal direction of the main body, each adjacent pair of the guide fingers being spaced apart from another by a prescribed spacing which is equal to a width of the apertures in the face plate in a direction of the row of apertures.

3. The alignment guide according to claim 2 wherein said at least one guide finger comprises three guide fingers defining two of said prescribed spacings between respective adjacent pairs of the guide fingers.

4. The alignment guide according to claim 2 further comprising a fastener aperture formed in the main body at a longitudinally centered location between each adjacent pair of the guide fingers.

5. The alignment guide according to claim 1 further comprising an end guide surface on the main body on opposing sides of said at least one guide finger, in which the end guide surfaces are co-linear with one another and in which the end guide surfaces are perpendicular to the finger guide surfaces.

6. The alignment guide according to claim 1 wherein the opposing sides of said at least one finger are tapered towards one another adjacent the free distal end.

7. The alignment guide according to claim 1 further comprising a level bubble supported on the guide to extend in the longitudinal direction of the main body so as to indicate angular deflection of the longitudinal direction from a horizontal plane.

8. A method of using the alignment guide according to claim 1, the method comprising:
mounting each electrical device in the multiple gang electrical box in said longitudinal row using a partially fastened first screw at a first end of each electrical device and a partially fastened second screw at a second end of each electrical device;
inserting a first guide finger among the at least one guide fingers of the alignment guide between a first electrical device and a second electrical device among the electrical devices mounted on the multiple gang electrical box such that the face portion of the first electrical device is abutted with one of the finger guide surfaces and the face portion of the second electrical device is abutted with another one of the finger guide surfaces; and
tightening the first screws of the first electrical device and the second electrical device while the face portions remain abutted with the finger guide surfaces of the first guide finger respectively.

9. The method according to claim 8 further comprising sliding the alignment guide into and out of engagement with the electrical devices along an axis parallel to the finger guide surfaces.

10. The method according to claim 8 further comprising:
abutting the main body against the face portion of the electrical devices at the first end of the electrical devices when tightening the first screws;
subsequently inserting the first guide finger between the first and second electrical devices until the main body is abutted against the face portion of the electrical device at the second end of the electrical devices; and
tightening the second screws of the first electrical device and the second electrical device while the face portions remain abutted with the finger guide surfaces of the first guide finger respectively.

11. The method according to claim 8 further comprising:
inserting the first guide finger between the second electrical device and a third electrical device among the electrical devices mounted on the multiple gang electrical box such that the face portion of the second electrical device is abutted with one of the finger guide surfaces and the face portion of the third electrical device is abutted with another one of the finger guide surfaces; and
tightening the first screw of the third electrical device while the face portions of the second and third electrical devices remain abutted with the finger guide surfaces of the first guide finger respectively.
